(19) United States
(12) Patent Application Publication
(10) Pub. No.: US 2007/0131093 A1
(43) Pub. Date: Jun. 14, 2007

(54) Sound system

(75) Inventor: Makoto Nagasue, Tokyo (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO., LTD., Tokyo (JP)

(21) Appl. No.: 11/517,335

(22) Filed: Sep. 8, 2006

(30) Foreign Application Priority Data
Dec. 14, 2005 (JP) 2005-360194

(51) Int. Cl. G10H 7/00

(52) U.S. Cl. 84/604

(57) ABSTRACT

A sound system includes, separately, a first clock generation section that generates a system clock for supply to a CPU or others via an internal bus, and a second clock generation section that generates a waveform synthesis clock for supply to a waveform synthesizer of a sound accelerator. The first clock generation section is so configured as to output a frequency corresponding to a value set by the CPU to a frequency setting register. Note here that the frequency of the second clock generation section may be set variable by the CPU. This enables operation with a further-optimum clock frequency so that the increase of power consumption caused by unnecessarily high-speed clock signals can be prevented in the sound system.

### BACKGROUND OF THE INVENTION

1. Field of the Invention

The present invention relates to a sound system for use with portable devices or others and, more specifically, to a technology for reducing the level of power consumption of the sound system.

2. Description of the Related Art

FIG. 1 is a diagram showing the configuration of a sound system of previous type.

This sound system receives music data such as MIDI (Musical Instrument Digital Interface) data, and outputs any desired PCM (Pulse Code Modulation) data such as instrument sounds. The sound system is provided with an MIDI memory 10 for storage of the MIDI data coming from a host CPU (Central Processing Unit) that is not shown. The MIDI memory 10 is connected to a CPU 30 via an internal bus 20. The internal bus 20 includes an address line 21, a data line 22, a control line 23, and a clock line 24. The address line 21 outputs an address ADR for the CPU 30 to specify a memory or peripheral circuit to be accessed, and the data line 22 transfers data DAT to the specified memory or peripheral circuit. The control line 23 outputs a control signal CON for operation control such as data reading and writing, and the clock line 24 supplies a system clock SCK for use as an operation reference.

The internal bus 20 is connected with a ROM (Read Only Memory) 40, a RAM (Random Access Memory) 50, a timer 60 for play time management, and a sound accelerator 70. The ROM 40 stores therein programs and data for processing by the CPU 30, and the RAM stores therein any data in process for a temporary basis.

The sound accelerator 70 performs waveform synthesis, and generates any desired PCM data for output. The waveform synthesis is performed based on parameters provided by the CPU 30 via the internal bus 20, e.g., sound allocation, interval, and volume. This sound accelerator 70 is configured by a parameter memory 71, and a waveform synthesizer 72. The parameter memory 71 receives and stores therein various parameters coming from the CPU 30 via the internal bus 20. The waveform synthesizer 72 generates PCM data by reading the parameters from the parameter memory 71, and forwards output signals LCH and RCH of the PCM data.

The sound system is also provided with a clock generation section 81 that generates a system clock SCK. The system clock SCK generated by the clock generation section 81 is used as a timing signal of operation reference for the CPU 30 or others connected to the internal bus 20 via the clock line 24, and as a clock signal for waveform synthesis in the waveform synthesizer 72.

Described next is the operation of the sound system.

The MIDI data provided by an external host CPU is stored in the MIDI memory 10 for a temporary basis, and then is read by the CPU 30 via the internal bus 20. The CPU 30 analyzes thus read MIDI data by following a processing program stored in the ROM 40 to make various parameter settings about sound allocation, interval, and volume. At this time, the RAM 50 is used as a working memory for such an analysis process, and the timer 60 is used for time management of sound play, i.e., timing control for execution of process corresponding to the analyzed MIDI data.

Thus set parameters are transferred to the parameter memory 71 of the sound accelerator 70 via the internal bus 20 for temporary storage therein. The parameters stored in the parameter memory 71 are read by the waveform synthesizer 72 for conversion into PCM data, and the results are output as output signals LCH and RCH.

The MIDI data is not of monophonic but of polyphonic, e.g., a plurality of instrument sounds. The waveform synthesizer 72 subjects the polyphonic sounds to a process in a time division manner so that the individual sounds are synthesized. The resulting synthesized sounds are added together, and the addition results are forwarded as a pair of right and left output signals LCH and RCH.

Such a sound system as above is described in Patent Document 1 (Japanese Patent Kokai No. 9-185370), for example.

### SUMMARY OF THE INVENTION

The above sound system, however, has the following problems.

That is, the sound system is configured to synthesize polyphonic sounds such as a plurality of instrument sounds, e.g. 64 sounds, in a time division manner using a single piece of the waveform synthesizer 72.

In proportion to the number of sounds for simultaneous synthesis, there thus needs to increase also the frequency of a waveform synthesis clock signal for supply to the waveform synthesizer 72. Herein, the waveform synthesis clock signal is also the system clock SCK used in the CPU 30 or others.

As a result, the larger number of sounds for synthesis causes the frequency increase of the system clock SCK needed for the waveform synthesis. This means that the CPU 30 or others are to be operated with the clock signal whose frequency is unnecessarily high, thereby resulting in the increase of power consumption. Such an increase of power consumption caused by operation with the unnecessarily-high clock frequency also affects the music play even with the fewer number of polyphonic sounds.

An object of the invention is to reduce the level of power consumption of a sound system.

An aspect of the invention is directed to a sound system, including: a processor unit that generates a parameter for use for waveform synthesis through analysis of input data provided from the outside; a sound accelerator that outputs audio data as a result of code modulation after the waveform synthesis performed in accordance with the parameter; a first clock generation section that outputs a first clock signal based on a frequency setting made by the processor unit for use as an operation reference in the processor unit; and a second clock generation section that outputs a second clock signal for the waveform synthesis in the sound accelerator.

In such a configuration, the processing in the processor unit and the waveform synthesis in the sound accelerator are both performed by clock signals, which are generated in each different clock generation sections. This enables both the processor unit and the sound accelerator to operate with the minimum necessary clock frequency so that the useless increase of the power consumption caused by unnecessarily high-speed clock signals can be prevented.

In the aspect, not only the first clock generation section but also the second clock generation section is allowed to change the frequency of the second clock signal. The frequency change is based on the frequency setting made by the processor unit for waveform synthesis. Moreover, in accordance with the power limit value that is externally provided, the processor unit makes the frequency setting for the first and second clock generation sections, and restricts the parameter generation for waveform synthesis.

### BRIEF DESCRIPTION OF THE DRAWINGS

FIG. 1 is a diagram showing the configuration of a previous sound system;

FIG. 2 is a diagram showing the configuration of a sound system in a first embodiment of the invention;

FIG. 3 is a diagram showing the configuration of a sound system in a second embodiment of the invention; and

FIG. 4 is a diagram showing the configuration of a sound system in a third embodiment of the invention.

### DETAILED DESCRIPTION OF THE INVENTION

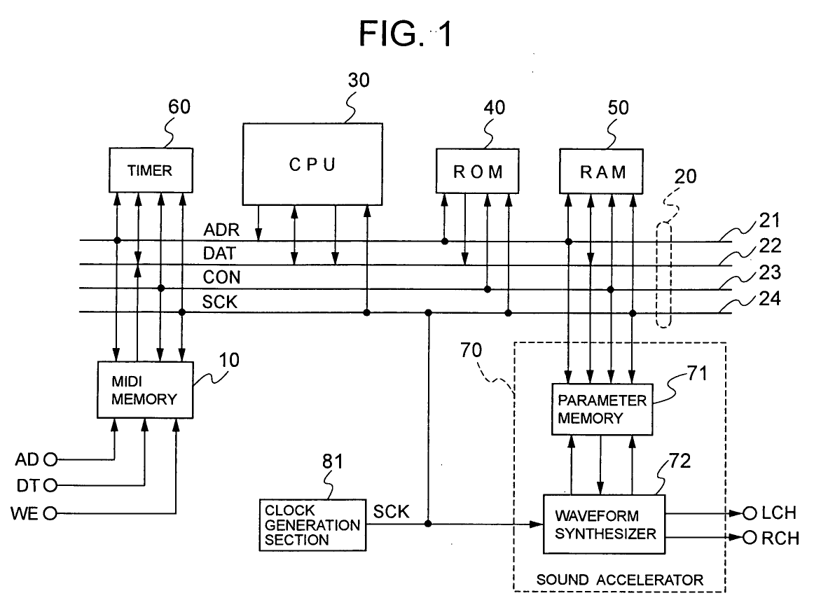

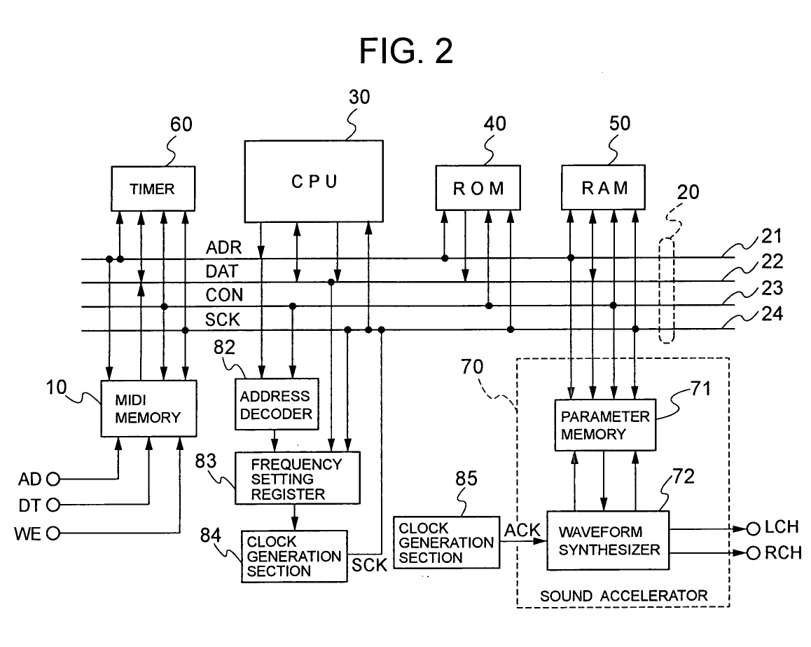

FIG. 2 is a diagram showing the configuration of a sound system in a first embodiment of the invention, and any component similar to that in FIG. 1 is provided with the same reference numeral.

This sound system receives music data such as MIDI data, and outputs any desired PCM data such as instrument sounds. The sound system is provided with the MIDI memory 10 for storage of the MIDI data coming from a host CPU that is not shown. The MIDI memory 10 is connected to the CPU 30 via the internal bus 20. The internal bus 20 includes the address line 21, the data line 22, the control line 23, and the clock line 24. The address line 21 outputs an address ADR for the CPU 30 to specify a memory or a peripheral circuit to be accessed, and the data line 22 transfers data DAT to the specified memory or peripheral circuit. The control line 23 outputs a control signal CON for operation control such as data reading and writing, and the clock line 24 supplies a system clock SCK for use as an operation reference.

The internal bus 20 is connected with the ROM 40, the RAM 50, the timer 60 for play time management, and the sound accelerator 70. The ROM 40 stores therein programs and data for processing use, and the RAM 50 stores therein any data in process for a temporary basis.

The sound accelerator 70 executes waveform synthesis, and generates any desired PCM data for output. The waveform synthesis is executed based on parameters provided by the CPU 30 via the internal bus 20, e.g., sound allocation, interval, and volume. This sound accelerator 70 is configured by the parameter memory 71, and the waveform synthesizer 72. The parameter memory 71 receives and stores therein various parameters coming from the CPU 30 via the internal bus 20. The waveform synthesizer 72 generates PCM data by reading the parameters from the parameter memory 71, and forwards output signals LCH and RCH of the PCM data.

The sound system is also provided with a clock generation section 84 that generates a system clock SCK, and another clock generation section 85 that generates a waveform synthesis clock ACK.

The clock generation section 84 is connected to the internal bus 20 via an address decoder 82 and a frequency setting register 83. The clock generation section 84 generates a clock signal of a frequency corresponding to a value set to the frequency setting register 83, and thus generated clock signal is output as a system clock SCK. The address decoder 82 is provided to write a setting value coming from the internal bus 20. Such value writing is made by forwarding a write control signal to the frequency setting register 83 in response to a write request to the frequency setting register 83 via the internal bus 20.

The clock generation section 85 generates a waveform synthesis clock ACK of a preset frequency.

Described next is the operation of the sound system.

In this sound system, the CPU 30 takes charge of sound processing except for the main part of the waveform synthesis, which is taken charge by the sound accelerator 70. The sound processing includes processes of analysis of incoming MIDI data, play time control, parameter setting for every analyzed MIDI message, and waveform synthesis.

Among such processes, the waveform synthesis taken charge by the sound accelerator 70 uses a single piece of the waveform synthesizer 72 to process polyphonic sounds in a time division manner. The sounds are all processed similarly except varying parameter values with some branching. Accordingly, the sounds share the same throughput, and the throughput for the entire waveform synthesis is proportionate to the number of playing polyphonic sounds.

As to the parameter setting for every MIDI message, the processing message type determines the throughput to be substantially uniform. For example, a note-on message requires A cycle, and a pitch-bend message requires B cycle. The throughput of the remaining message analysis and time control is not always the same because with a lot of branching, but is reduced considerably compared with the waveform synthesis and parameter setting.

The operation clock frequency CPU-Fsamp needed for the CPU 30 is thus expressed as the following equation 1.
CPU-Fsamp=CSynMIPS×Poly+MsgMIPS+ResMIPS equation 1

In the equation 1, the value of CSynMIPS denotes the system-basis throughput of the waveform synthesis executed by the CPU for a sound, the value of Poly denotes the number of playing polyphonic sounds, the value of MsgMIPS denotes the system-basis throughput for each of various messages, and ResMIPS denotes the throughput of any remaining additional processing.

During music play, the values of Poly and MsgMIPS in the equation 1 are changed based on the number of playing polyphonic sounds and an input MIDI message, and the resulting operation clock frequency CPU-Fsamp is set to the frequency setting register 83. Thus set frequency is reflected as a system clock SCK so that the frequency of the system clock SCK can be optimized for the CPU 30.

The value of MsgMIPS may be stored in the ROM 40 as fixed data in a table format, and left available for the CPU 30 to freely refer to. The value of ResMIPS may be set with any possible maximum value as a fixed value because the throughput thereof is not easily obtained. The value is negligibly small compared with others in the equation 1, and this thus causes no problem.

As described above, the sound system of this embodiment 1 is configured by the frequency setting register 83 that can be set with a value by the CPU 30, and the clock generation section 84 that generates a clock signal of a frequency corresponding to the value set to the frequency setting register 83, and outputs the result as a system clock SCK. Such a configuration enables to change the frequency of the system clock SCK based on the number of playing polyphonic sounds and the type of an input MIDI message, thereby advantageously optimizing the level of power consumption in the CPU 30 and its peripheral. circuits.

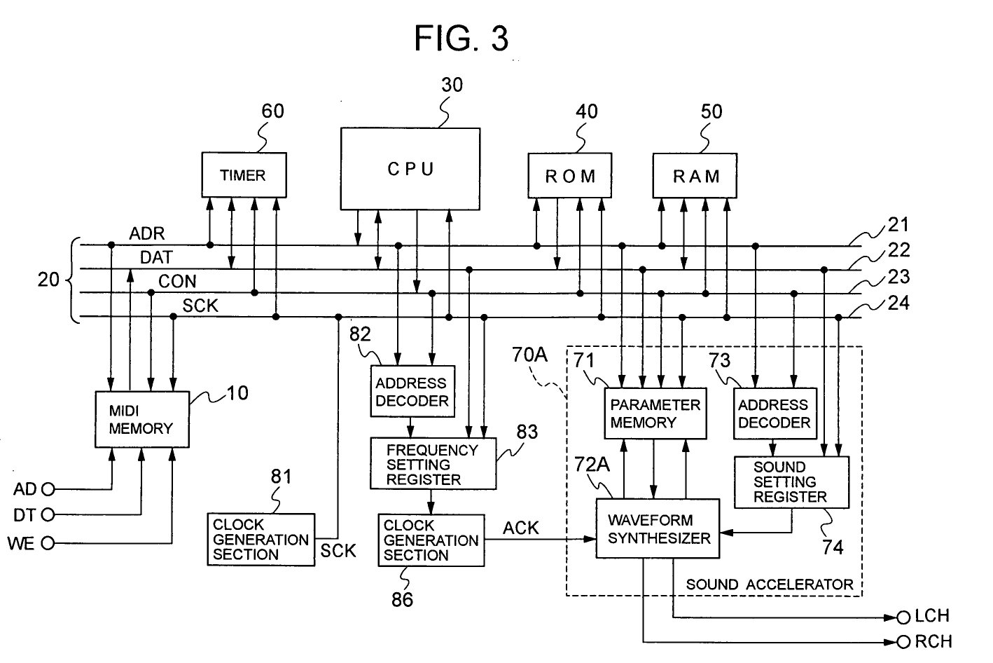

FIG. 3 is a diagram showing the configuration of a sound system in a second embodiment of the invention, and any component similar to that in FIG. 2 is provided with the same reference numeral.

In this sound system, the clock generation section 84 in FIG. 1 is replaced with a clock generation section 81 that generates a system clock SCK of a preset frequency, and the clock generation section 85 is replaced with a clock generation section 86 that generates a clock signal of a frequency corresponding to the value set to the frequency setting register 83, and outputs a waveform synthesis clock ACK.

The sound accelerator 70 is replaced with a sound accelerator 70A in which a register 74 is additionally provided to set the number of sounds (hereinafter, referred to as sound setting register 74). The sound setting register 74 is a control register that is available for the CPU 30 to set the number of playing polyphonic sounds via the internal bus 20. The value set to this sound setting register 74 is supplied to a waveform synthesizer 72A. The remaining structure components are the same as those of FIG. 2.

Described next is the operation of the sound system.

The CPU 30 performs sound allocation in the process of MIDI messages such as note-on or note-off messages so that the number of currently-playing polyphonic sounds is managed. When some change is observed in the number of polyphonic sounds, the CPU 30 sets a value corresponding to the number of polyphonic sounds to the frequency setting register 83. With such a value setting, the clock generation section 86 changes the frequency of the waveform synthesis clock ACK in accordance with the value set to the frequency setting register 83. Note here that the CPU 30 sets the value to the frequency setting register 82 in such a manner that the waveform synthesis clock ACK satisfies the waveform synthesis clock frequency ACC-Fsamp as in the following equation 2.
ACC-Fsamp=ASynMIPS×Poly Equation 2

In the equation 2, the value of ASynMIPS denotes the system-basis throughput of the waveform synthesis executed by the sound accelerator for a sound, and the value of Poly denotes the number of playing polyphonic sounds.

In the sound accelerator 70A, a processing time slot is prepared for performing waveform synthesis for every sound. The waveform synthesizer 72A goes through the processing time slots as many as the number of polyphonic sounds, i.e., the value set to the sound setting register 74, and completes the operation per unit time. As such, the sound accelerator 70A includes the execution element on a sound basis, and the information about the number of playing polyphonic sounds is used as a basis to control the frequency of running the execution element.

As such, the sound system of this second embodiment is provided with the frequency setting register 83 that can be set with a value by the CPU 30, and the clock generation section 86 that generates a clock signal of a frequency corresponding to the value set to the frequency setting register 83, and outputs the result as a waveform synthesis clock ACK. This enables to change the frequency of the waveform synthesis clock ACK based on the number of playing polyphonic sounds so that the level of power consumption can be advantageously optimized in the sound accelerator 70A.

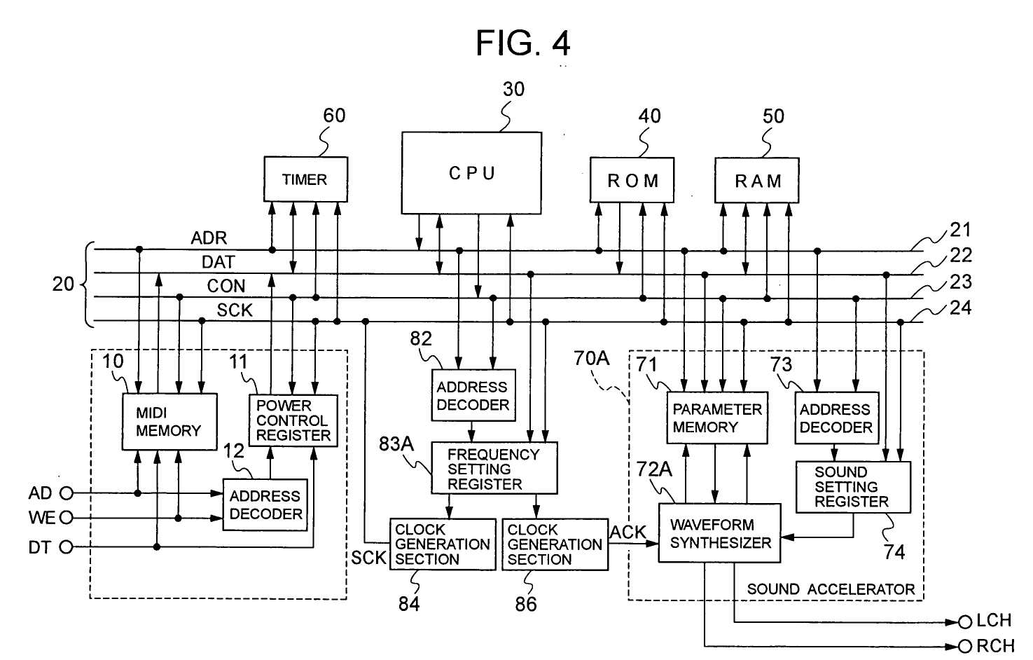

FIG. 4 is a diagram showing the configuration of a sound system in a third embodiment of the invention, and any component similar to that in FIG. 3 is provided with the same reference numeral.

In this sound system, the clock generation section 81 in FIG. 3 is replaced with the clock generation section 84 that generates a clock signal of a frequency corresponding to a setting value, and outputs the result as a system clock SCK. The frequency setting register 83 is replaced with a frequency setting register 83A that can keep a setting value of the clock generation section 84 separately from that of the clock generation section 86.

This sound system is provided with a power control register 11 for a host CPU to set a limit value of power consumption. The power control register 11 is connected to the internal bus 20 to be available for the CPU 30 to refer to. The remaining structure components are the same as those of FIG. 3.

In such a sound system, similarly to the first and second embodiments, during music play, calculations are made for the operation clock frequency CPU-Fsamp and the waveform synthesis clock frequency ACC-Fsamp by following the equations 1 and 2 based on the number of playing polyphonic sounds and input MIDI data, and the level of power consumption is optimized by changing the frequencies of the clock generation sections 84 and 86 through the frequency setting register 83A.

The operation of restricting the level of power consumption is executed by an external host CPU setting a limit value to the power control register 11.

The CPU 30 first reads the value set to the power control register 11 through the internal bus 20. Thus read value is then converted into a value of clock frequency. The operation clock frequency CPU-Fsamp in the equation 1 and the waveform synthesis clock frequency ACC-Fsamp in the second equation 2 are so controlled as to be lower than the frequency of the conversion result.

When the input MIDI message is a note-on message, the number of playing polyphonic sounds is increased by 1 after the message execution is through. Therefore, with the value of Poly increased by 1 in the equations 1 and 2, a determination is made whether the frequencies CPU-Fsamp and ACC-Fsamp are equal to or lower than the clock frequency of the conversion result. When the determination is made that conditions are satisfied, the message is executed in a normal manner. When the determination is made that the conditions are not satisfied, the message is discarded without execution. Such a determination is made not only to the note-on messages but to every message, and limits are so imposed on a throughput that the frequencies CPU-Fsamp and ACC-Fsamp are always equal to or lower than the clock frequency of the conversion result.

As described in the foregoing, the sound system of the third embodiment is provided with the frequency setting register 83A that can be set with a value by the CPU 30, and the clock generation sections 84 and 86 both generating a clock signal of a frequency corresponding to the value set to the frequency setting register 83A. The clock generation section 84 outputs a system clock SCK, and the clock generation section 86 outputs a waveform synthesis clock ACK. This configuration favorably leads to the same effects as those in the first and second embodiments.

Moreover, this sound system of the third embodiment is so configured as to impose limits on a throughput by making a determination whether or not to execute a message while using the throughput as a calculation basis. This accordingly restricts the frequencies of the system clock SCK and the waveform synthesis clock ACK, and the sound system accordingly plays sounds with the power consumption restricted in value to satisfy the value provided by the host CPU. This advantageously serves well when the battery of a portable device needs recharging, for example. In such a case, the power consumption is restricted so as to buy time until the battery becomes flat with some level of music quality.

Note here that the invention is surely not restrictive to the third embodiment, and numerous other modifications and variations can be devised. As a modified example, limits may be imposed only on the number of the playing polyphonic sounds because the throughput thereof is much larger than that of message processing. When the music quality is a significant factor, any important message is executed without fail, and when the processing is not enough, a sound may be skipped during the play.

What is claimed is:

1. A sound system, comprising:
a processor unit that generates a parameter for use for waveform synthesis through analysis of input data provided from outside;
a sound accelerator that outputs audio data as a result of code modulation after the waveform synthesis performed in accordance with the parameter;
a first clock generation section that outputs a first clock signal based on a frequency setting made by the processor unit for use as an operation reference in the processor unit; and
a second clock generation section that outputs a second clock signal for the waveform synthesis in the sound accelerator.

2. A sound system, comprising:
a processor unit that generates a parameter for use for waveform synthesis through analysis of input data provided from outside;
a sound accelerator that outputs audio data as a result of code modulation after the waveform synthesis performed in accordance with the parameter;
a first clock generation section that outputs a first clock signal for use as an operation reference in the processor unit; and
a second clock generation section that outputs a second clock signal based on a frequency setting made by the processor unit for the waveform synthesis in the sound accelerator.

3. A sound system, comprising:
a processor unit that generates a parameter for use for waveform synthesis through analysis of input data provided from outside;
a sound accelerator that outputs audio data as a result of code modulation after the waveform synthesis performed in accordance with the parameter;
a first clock generation section that outputs a first clock signal based on a frequency setting made by the processor unit for use as an operation reference in the processor unit; and
a second clock generation section that outputs a second clock signal based on a frequency setting made by the processor unit for the waveform synthesis in the sound accelerator.

4. The sound system according to claim 1, wherein
in accordance with a power limit value provided from the outside, the processor unit restricts a value of the frequency setting for the second clock generation section.

5. The sound system according to claim 3, wherein
in accordance with a power limit value provided from the outside, the processor unit restricts a value of the frequency setting for the second clock generation section.

6. The sound system according to claim 2, wherein
in accordance with a power limit value provided from the outside, the processor unit restricts a value of the frequency setting for the first clock generation section.

7. The sound system according to claim 3, wherein
in accordance with a power limit value provided from the outside, the processor unit restricts a value of the frequency setting for the first clock generation section.

8. The sound system according to claim 3, wherein
in accordance with a power limit value provided from the outside, the processor unit restricts a value of the frequency setting for the first clock generation section, and a value of the frequency setting for the second clock generation section.

9. The sound system according to claim 1, wherein
the processor unit restricts generation of the parameter for the waveform synthesis in accordance with the power limit value provided from outside.

10. The sound system according to claim 2, wherein
the processor unit restricts generation of the parameter for the waveform synthesis in accordance with the power limit value provided from outside.

11. The sound system according to claim 3, wherein
the processor unit restricts generation of the parameter for the waveform synthesis in accordance with the power limit value provided from outside.

12. The sound system according to claim 4, wherein
the processor unit restricts generation of the parameter for the waveform synthesis in accordance with the power limit value provided from outside.

13. The sound system according to claim 5, wherein
the processor unit restricts generation of the parameter for the waveform synthesis in accordance with the power limit value provided from outside.

14. The sound system according to claim 6, wherein
the processor unit restricts generation of the parameter for the waveform synthesis in accordance with the power limit value provided from outside.

15. The sound system according to claim 7, wherein
the processor unit restricts generation of the parameter for the waveform synthesis in accordance with the power limit value provided from outside.

16. The sound system according to claim 8, wherein
the processor unit restricts generation of the parameter for the waveform synthesis in accordance with the power limit value provided from outside.

17. The sound system according to claim 1, wherein said input data provided from outside is MIDI data from a host CPU outside the sound system.

18. The sound system according to claim 2, wherein said input data provided from outside is MIDI data from a host CPU outside the sound system.

19. The sound system according to claim 3, wherein said input data provided from outside is MIDI data from a host CPU outside the sound system.
